(19) United States
(12) Patent Application Publication
(10) Pub. No.: US 2026/0346713 A1
(43) Pub. Date: Nov. 5, 2026

(54) DISPLAY UNIT AND MOBILE BODY

(71) Applicant: Panasonic Intellectual Property Management Co., Ltd., Osaka (JP)

(72) Inventors: HITOSHI TOMINAGA, Kyoto (JP); ATSUSHI SAKAGUCHI, Kyoto (JP); YUKIHIRO MORITA, Osaka (JP); NAOKI SAITO, Tokyo (JP); MARINA TSUJI, Tokyo (JP)

(21) Appl. No.: 19/716,338

(22) Filed: Jun. 23, 2026

Related U.S. Application Data
(63) Continuation of application No. PCT/JP2024/045400, filed on Dec. 23, 2024.

(30) Foreign Application Priority Data
Jan. 9, 2024 (JP) 2024-001208

(51) Int. Cl. B60K 35/22; B60K 35/231; B60K 35/233; B60K 35/60; B60K 35/81

(52) U.S. Cl. CPC B60K 35/22; B60K 35/231; B60K 35/233; B60K 35/60; B60K 35/81; B60K 2360/66

(57) ABSTRACT

A display unit to be disposed in a mobile body includes a transparent image projection member that has a display surface and a back surface, and a light blocking screen that opens and closes so as to face the back surface. The image projection member is positioned between a rear seat of the mobile body and the light blocking screen, and is disposed so that the display surface and a view in a travelling direction of the mobile body overlap as seen from the rear seat.

### BACKGROUND

### 1. Technical Field

The present disclosure relates to techniques for displaying image contents on a transparent image projection member.

### 2. Description of the Related Art

In recent years, there has been known a technique for allowing a user to simultaneously see an image displayed on a display surface of an image projection member and a view behind the image projection member by using a transparent image projection member such as an organic EL (Electro-Luminescence) display. For example, Japanese Unexamined Patent Application Publication No. 2020-79917 describes that a transparent display is provided between a windshield and a driver's seat and the transmittance of a light blocking image displayed on the back side of an image displayed on the transparent display is adjusted in accordance with the intensity of light propagating toward the transparent display.

### SUMMARY

Japanese Unexamined Patent Application Publication No. 2020-79917 only discloses control for adjusting the visibility of a transparent display in a driver's seat of a mobile body and does not consider adjusting the visibility of each of a view in the travelling direction of the mobile body and the transparent display in a rear seat of the mobile body.

One non-limiting and exemplary embodiment provides a technique for effectively switching between a state in which the visibility of a view in the travelling direction of a mobile body is high and a state in which the visibility of a display surface of a transparent image projection member is high in a rear seat of the mobile body.

In one general aspect, the techniques disclosed here feature a display unit to be disposed in a mobile body, including: a transparent image projection member that has a display surface and a back surface; and a light blocking screen that opens and closes so as to face the back surface. The image projection member is positioned between a rear seat of the mobile body and the light blocking screen, and is disposed so that the display surface and a view in a travelling direction of the mobile body overlap as seen from the rear seat.

With the present disclosure, it is possible to effectively switch between a state in which the visibility of a view in the travelling direction of the mobile body is high and a state in which the visibility of the display surface of the transparent image projection member is high in the rear seat of the mobile body.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of a top view of a vehicle including a display unit;

FIG. 2 illustrates an example of a side view of the vehicle when a light blocking screen is in an open state;

FIG. 3 illustrates an example of a side view of the vehicle when the light blocking screen is in a closed state;

FIG. 4 illustrates an example of the position where a seat stopper is disposed;

FIG. 5 illustrates an example of a side view of the display unit;

FIG. 6 illustrates an example of a perspective view of the display unit;

FIG. 7 illustrates an example of a front view of the display unit;

FIG. 8 is a block diagram illustrating an example of the electrical configuration of the display unit;

FIG. 9 illustrates an example of the visibility of a transparent display in a rear seat;

FIG. 10 illustrates an example of the visibility of the transparent display in the rear seat; and

FIG. 11 illustrates an example of the visibility of the transparent display in the rear seat.

### DETAILED DESCRIPTIONS

### Underlying Knowledge Forming Basis of the Present Disclosure

As described above, in recent years, there has been known a technique for allowing a user to simultaneously see an image displayed on a display surface of an image projection member and a view behind the image projection member by using a transparent image projection member such as an organic EL display. For example, it has been examined to use this technique in various occasions, such as an occasion for allowing the driver of a mobile body, such as an automobile, to simultaneously see a view in the travelling direction of the mobile body and an image related to the view, as described in Japanese Unexamined Patent Application Publication No. 2020-79917.

Unlike Japanese Unexamined Patent Application Publication No. 2020-79917, the inventor has examined the use of the above technique for an occupant in a rear seat, who need not continue to carefully watch a view in the travelling direction of the mobile body. In this examination, the inventor found that, when an occupant in a rear seat simultaneously sees an image displayed on a transparent image projection member and a view behind the image projection member, the frequency at which the occupant feels poor physical condition such as carsickness, headache, or the like is reduced, although the visibility of the image decreases.

From this finding, the inventor considered that, in order to make the rear seat of the mobile body be an environment that is comfortable for an occupant, a state in which the visibility of a view in the travelling direction of the mobile body is high and a state in which the visibility of the display surface of the transparent image projection member is high in a rear seat may be effectively switched. A view behind the image projection member may be interpreted as a view that is recognized by the driver of the mobile body through the windshield of the mobile body.

Based on the above finding, the inventor intensively investigated techniques for effectively switching between a state in which the visibility of a view in the travelling direction of the mobile body is high and a state in which the visibility of the display surface of the transparent image projection member is high in a rear seat of the mobile body, and conceived of each aspect of the present disclosure described below.
(1) A display unit according to an aspect of the present disclosure is a display unit to be disposed in a mobile body. The display unit includes a transparent image projection member that has a display surface and a back surface, and a light blocking screen that opens and closes so as to face the back surface. The image projection member is positioned between a rear seat of the mobile body and the light blocking screen, and is disposed so that the display surface and a view in a travelling direction of the mobile body overlap as seen from the rear seat.

With this configuration, by opening the light blocking screen, it is possible to transmit light that travels from the back surface toward the display surface of the image projection member and to increase the visibility of the view in the travelling direction of the mobile body in the rear seat of the mobile body. On the other hand, with this configuration, by closing the light blocking screen, it is possible to block light that travels from the back surface toward the display surface of the image projection member and to increase the visibility of the display surface in the rear seat of the mobile body. That is, with this configuration, by opening and closing the light blocking screen, it is possible to effectively switch between a state in which the visibility of the view in the travelling direction of the mobile body is high and a state in which the visibility of the display surface of transparent image projection member is high in the rear seat of the mobile body.
(2) In the display unit according to (1), the light blocking screen may be a roll screen that winds up a sheet-like light blocking member, and a winding slot for the light blocking member may be provided at a position that is closer than a winding shaft for the light blocking member to the back surface.

With this configuration, because the winding slot for the light blocking member is provided at a position closer than the winding shaft for the light blocking member to the back surface of the image projection member, it is possible to reduce the risk that the front seat of the mobile body contacts the light blocking member when the front seat is moved toward the rear seat due to reclining or the like.
(3) The display unit according to (1) may further include a stopper member that stands between a front seat of the mobile body and the light blocking screen so as to face the front seat.

With this configuration, because the stopper member that stands so as to face the front seat of the mobile body is provided between the front seat and the light blocking screen, it is possible to limit the movable range when the front seat is moved toward the rear seat. Thus, it is possible to reduce the risk that the front seat contacts the light blocking screen.
(4) In the display unit according to (1), the light blocking screen may be a roll screen that winds up a sheet-like light blocking member, the light blocking member may include one end at which a weight bar is provided and the other end at which a winding shaft is provided, the one end may face the other end, and the display unit may further include, in a direction from the winding shaft along the back surface, a bracket that removably holds the weight bar with a magnetic force.

With this configuration, by pulling out the weight bar, which is located at one end of the light blocking member opposite from the winding shaft, along the back surface and by causing the weight bar to contact the bracket, it is possible to fix the weight bar to the bracket with a magnetic force in a state in which the light blocking member faces the back surface. Thus, it is possible to block light that travels from the back surface to the display surface of the image projection member and it is possible to reduce movement of the light blocking member due to vibration of the mobile body. As a result, it is possible to reduce the risk that the light blocking member contacts the image projection member.
(5) The display unit according to (1) may further include a control circuit, the control circuit may display image contents on the display surface, the image contents may include phases, and the control circuit may control opening and closing of the light blocking screen in accordance with a phase displayed on the display surface.

With this configuration, it is possible to guide an occupant in the rear seat to various states corresponding to the phases displayed on the display surface.
(6) In the display unit according to (5), the phases may include a relaxing phase for guiding an occupant in the rear seat to a relaxed state, a sleeping phase for guiding the occupant to a sleeping state, and an awakening phase for guiding the occupant to an awakened state.

With this configuration, it is possible to guide an occupant in the rear seat to the relaxed state, the sleeping state, or the awakened state in accordance with the phase displayed on the display surface.
(7) In the display unit according to (3), the stopper member may be disposed so as to satisfy (b/a)<(A/B), where a is a distance from a bottom surface of the front seat to an upper end of the stopper member in an up-down direction of the mobile body, b is a distance from a rear end of the bottom surface of the front seat to the stopper member in the travelling direction of the mobile body, A is a distance in the up-down direction from the bottom surface of the front seat to a point of contact between the front seat and the light blocking screen when the front seat is in contact with the light blocking screen, and B is a distance from the light blocking screen to the rear end of the bottom surface of the front seat in the travelling direction.

With this configuration, it is possible to reduce the risk that the front seat contacts the light blocking screen when the front seat is reclined.
(8) The display unit according to (1) may further include a control circuit, and the control circuit may control opening and closing of the light blocking screen in accordance with a command that is input by an occupant of the mobile body.

With this configuration, it is possible for an occupant of the mobile body to control opening and closing of the light blocking screen at any appropriate timing in consideration of the physical condition and/or mood of the occupant.
(9) A mobile body according to another aspect of the present disclosure is a mobile body including a display unit. The display unit includes a transparent image projection member that has a display surface and a back surface, and a light blocking screen that opens and closes so as to face the back surface. The image projection member is positioned between a rear seat of the mobile body and the light blocking screen, and is disposed so that the display surface and a view in a travelling direction of the mobile body overlap as seen from the rear seat.

With this configuration, advantageous effects similar to those of the display unit according to (1) are obtained.

Embodiments described below each represent a specific example of the present disclosure. Numeric values, shapes, constituent elements, processing, the order of processing, and the like are each an example, and are not intended to limit the present disclosure. Constituent elements in the following embodiments that are not described in the independent claim, which defines the most general concept, are described as optional constituent elements. The contents of any of the embodiments may be used in any appropriate combination.

Hereafter, embodiments of the present disclosure will be described with reference to the drawings.

### First Embodiment

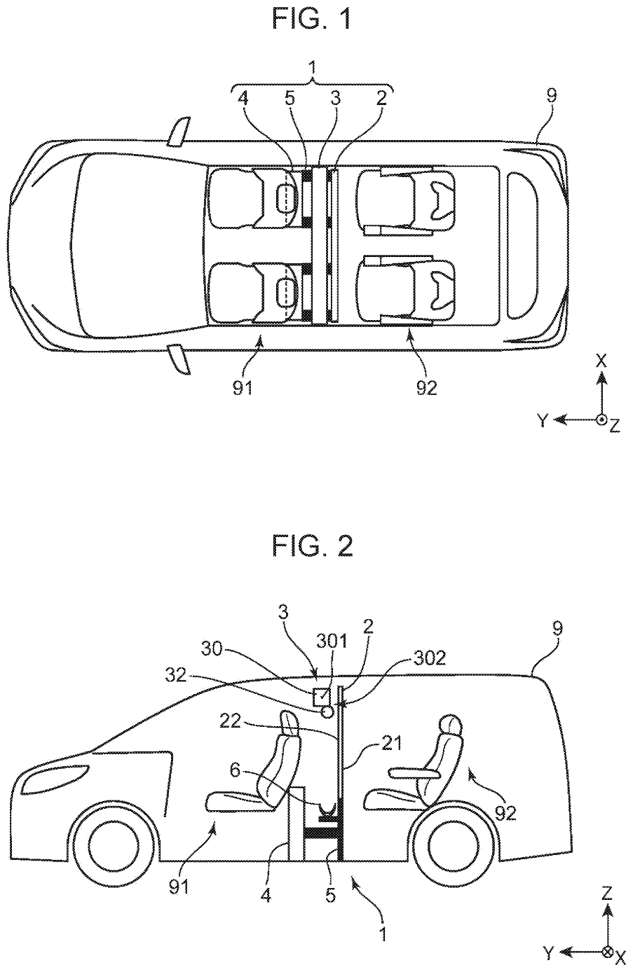

FIG. 1 illustrates an example of a top view of a vehicle 9 including a display unit 1. In the following description, as illustrated at the lower right corner of FIG. 1, the front-back direction or the Y direction indicates the travelling direction of the vehicle 9, the forward direction or the +Y direction indicates the direction in which the vehicle 9 travels forward, and the backward direction or the −Y direction indicates the direction in which the vehicle 9 travels backward. The up-down direction or the Z direction indicates the direction perpendicular to the ground on which the vehicle 9 travels, the downward direction or the −Z direction indicates the direction from the vehicle 9 toward the ground, on which the vehicle 9 travels, in the up-down direction, and the upward direction or the +Z direction indicates the direction opposite to the downward direction and the −Z direction. The left-right direction or the X direction indicates the direction perpendicular to the front-back direction (the Y direction) and the up-down direction (the Z direction). In the left-right direction and the X direction, the rightward direction or the +X direction indicates the direction toward the right with respect to the direction in which the vehicle 9 travels forward, and the leftward direction or the −X direction indicates the direction toward the left with respect to the direction in which the vehicle 9 travels forward.

As illustrated in FIG. 1, the display unit 1 is disposed, for example, between a front seat 91 and a rear seat 92 of the vehicle 9 (mobile body), which is a passenger car, a bus, a taxi, or the like. To be specific, the display unit 1 includes a transparent display (image projection member) 2, a light blocking screen 3, a seat stopper 4 (stopper member), and a frame 5 that supports these.

The front seat 91 includes the driver's seat of the vehicle 9. The rear seat 92 does not include the driver's seat of the vehicle 9.

For example, when the vehicle 9 is a so-called three-row seat vehicle and the seats in the first row include the driver's seat and a passenger seat, the seats in the second row and the seats in the third row each may be the rear seat 92, and the driver's seat and the passenger seat included in the seats in the first row each may be the front seat 91. Alternatively, the seats included in the seats in the third row each may be the rear seat 92, and the driver's seat and the passenger seat included in the seats in the first row and the seats included in the seats in the second row each may be the front seat 91.

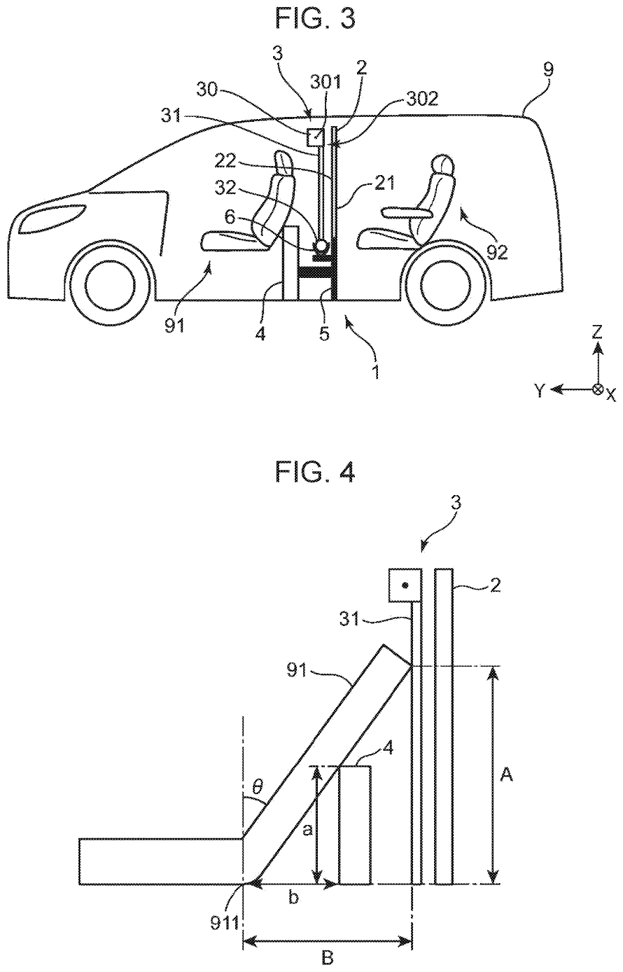

FIG. 2 illustrates an example of a side view of the vehicle 9 when the light blocking screen 3 is in an open state. FIG. 3 illustrates an example of a side view of the vehicle 9 when the light blocking screen 3 is in a closed state. As illustrated in FIGS. 2 and 3, the transparent display 2, which is a panel-like transparent member, has a transparent rectangular display surface 21 that displays image contents toward the rear seat 92, that is, in the −Y direction, and has a transparent rectangular back surface 22 on a side opposite from the display surface 21.

The transparent display 2 is supported by the frame 5, in such a way that the longitudinal direction thereof coincides with the X direction, at a position between the rear seat 92 of the vehicle 9 and the light blocking screen 3 so that the display surface 21 and a view in the travelling direction of the vehicle 9 (the Y direction) overlap as seen from the rear seat 92. The transparent display 2 displays image contents on the display surface 21 under control by a control circuit 7 described below (FIG. 8). The transparent display 2 is, for example, a transparent organic EL display. The transparent display 2 has a predetermined light transmittance that is greater than or equal to 80%, is greater than or equal to 90%, or is 100%.

A transparent light control film (light control sheet), which adjusts the light blocking ratio (light transmittance) of the back surface 22 under control by the control circuit 7 described below (FIG. 8), may be superposed on the back surface 22 of the transparent display 2. A projector may be provided on an upper rear part of the rear seat 92 of the vehicle 9 or the like, and the transparent display 2 may be made of translucent glass. Thus, image contents may be displayed on the display surface 21 by projecting the image contents onto the display surface 21 of glass under the control of the control circuit 7 described below (FIG. 8).

The light blocking screen 3 is a roll screen that winds up a sheet-like light blocking member 31, and opens and closes in the up-down direction (the Z direction) so as to face the back surface 22 of the transparent display 2. The dimension of the light blocking member 31 in the longitudinal direction is greater than the dimension of the transparent display 2 in the longitudinal direction, and the dimension of the light blocking member 31 in the transversal direction is also greater than the dimension of the transparent display 2 in the transversal direction. The light blocking member 31 has a predetermined light blocking ratio that is 100% (fully light blocking) or is greater than or equal to 95%.

FIG. 2 illustrates an example of a state in which the light blocking screen 3 is open (hereafter, an open state), and FIG. 3 illustrates an example of a state in which the light blocking screen 3 is closed (hereafter, a closed state). To be specific, the light blocking screen 3 includes a winder 30 that opens and closes the sheet-like light blocking member 31 in the up-down direction.

The winder 30 includes a motor (not shown) that is controlled by the control circuit 7 described below (FIG. 8), and a winding shaft 301 that is rotated by the motor around an axis (hereafter, X axis) parallel to the left-right direction (the X direction).

One end of the light blocking member 31 is attached to the winding shaft 301 in the winder 30. One end of the light blocking member 31 opposite from the winding shaft 301, that is, in the −Z direction is pulled out downward and is wound upward from a winding slot 302 as the winding shaft 301 is rotated around the X axis by the motor included in the winder 30. The winding slot 302 is provided at a position closer than the winding shaft 301 to the back surface 22. A weight bar 32, which is made of a metal, is attached to one end of the light blocking member 31 on the side opposite from the winding shaft 301, that is, in the −Z direction.

A bracket 6, which removably holds the weight bar 32 with a magnetic force, is provided at a position below the back surface 22 in a direction from the winding shaft 301 along the back surface 22 of the transparent display 2. The bracket 6 is supported by the frame 5. A part or all of an upper surface of the bracket 6 is made of a member having a magnetic force, such as a magnet.

Therefore, when one end of the light blocking member 31, to which the weight bar 32 is attached, is pulled out by the winder 30 from the winding slot 302 downward along the back surface 22 and the weight bar 32 contacts the upper surface of the bracket 6, the weight bar 32, which is made of a metal, becomes fixed to the bracket 6 by a magnetic force. Thus, the light blocking screen 3 enters a closed state, and light that travels from the back surface 22 toward the display surface 21 of the transparent display 2 is blocked by the light blocking member 31, whose dimensions in the longitudinal direction and the transversal direction are greater than those of the back surface 22. As a result, it is possible to increase the visibility of the display surface 21 in the rear seat 92 of the vehicle 9.

On the other hand, when one end of the light blocking member 31 to which the weight bar 32 is attached is wound up by the winder 30 to the winding slot 302, the weight bar 32 contacts the winding slot 302 and becomes fixed. Thus, the light blocking screen 3 enters an open state, and light that travels from the back surface 22 toward the display surface 21 of the transparent display 2 is transmitted. As a result, it is possible to increase the visibility of the view in the travelling direction of the vehicle 9 in the rear seat 92 of the vehicle 9.

At least a region of the peripheral surface of the weight bar 32 that contacts the bracket 6 may be made of a member having a magnetic force, such as a magnet, and the bracket 6 may be made of a metal. Alternatively, at least a region of the peripheral surface of the weight bar 32 that contacts the bracket 6 and a part or all of the region of the upper surface of the bracket 6 may include magnets having magnetic poles that are different from each other.

When the weight bar 32 is made of a metal and a part or all of the region of the upper surface of the bracket 6 is made of a member having a magnetic force as described above, it is possible to prevent the weight bar 32 from becoming attached to a metal in the vicinity of the front seat 91 while the weight bar 32 is moving from the winding slot 302 to the bracket 6.

The seat stopper 4 is screwed to the frame 5 so that the seat stopper 4 stands between each of two front seats 91 (FIGS. 1 to 3) and the light blocking screen 3 so as to face the front seat 91. Thus, it is possible to limit the movable range when the front seat 91 is moved toward the rear seat 92 for reclining or the like. As a result, it is possible to reduce the risk that the front seat 91 contacts the light blocking screen 3.

The seat stopper 4 may be disposed, for example, as follows. FIG. 4 illustrates an example of the position where the seat stopper 4 is disposed. Hereafter, as illustrated in FIG. 4, “θ” denotes the angle between the front seat 91 and a plane parallel to the light blocking member 31 when the front seat 91 is reclined until the front seat 91 contacts the light blocking member 31, and “A” denotes the distance in the up-down direction (the Z direction) from the bottom surface of the front seat 91 to the point of contact between the front seat 91 and the light blocking member 31. “B” denotes the distance from the light blocking member 31 to a rear end 911 of the bottom surface of the front seat 91 in the front-back direction (the Y direction). “a” denotes the distance from the bottom surface of the front seat 91 to the upper end of the seat stopper 4 in the up-down direction (the Z direction), and “b” denotes the distance from the rear end 911 of the front seat 91 to the seat stopper 4 in the front-back direction (the Y direction).

As illustrated in FIG. 4, when the front seat 91 is in contact with the light blocking member 31, a relational expression “b=a×tan θ” is satisfied. Therefore, in order to prevent the front seat 91 from contacting the light blocking member 31, the seat stopper 4 may be disposed so that the relational expression “b <(a×tan θ)” is satisfied. Because “tan θ” is equal to “A/B”, the relational expression “b <(a×tan θ)” can be transformed into a relational expression “(b/a)<(A/B)”.

That is, the seat stopper 4 may be disposed so as to satisfy a relational expression “(b/a)<(A/B)”, where “a” is the distance from the bottom surface of the front seat 91 to the upper end of the seat stopper 4 in the up-down direction (the Z direction), “b” is the distance from the rear end 911 of the front seat 91 to the seat stopper 4 in the front-back direction (the Y direction), “A” is the distance in the up-down direction (the Z direction) from the bottom surface of the front seat 91 to the point of contact between the front seat 91 and the light blocking member 31 when the front seat 91 is in contact with the light blocking member 31, and “B” is the distance from the light blocking member 31 to the rear end 911 of the bottom surface of the front seat 91 in the front-back direction (the Y direction).

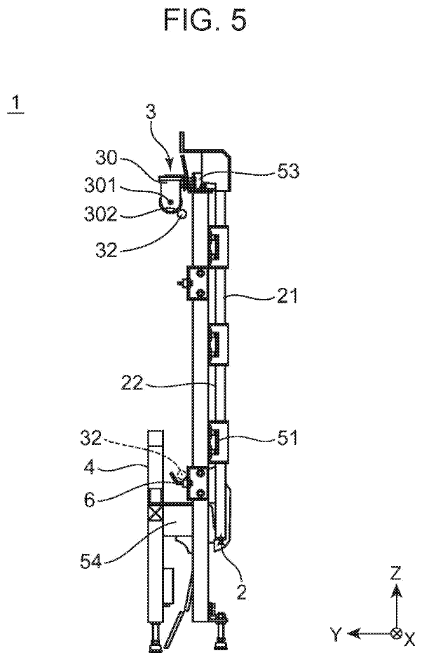

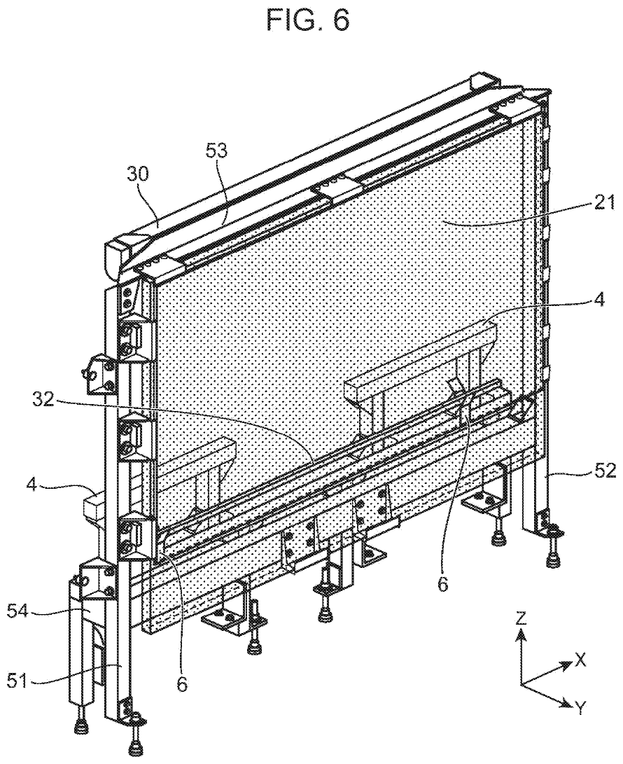

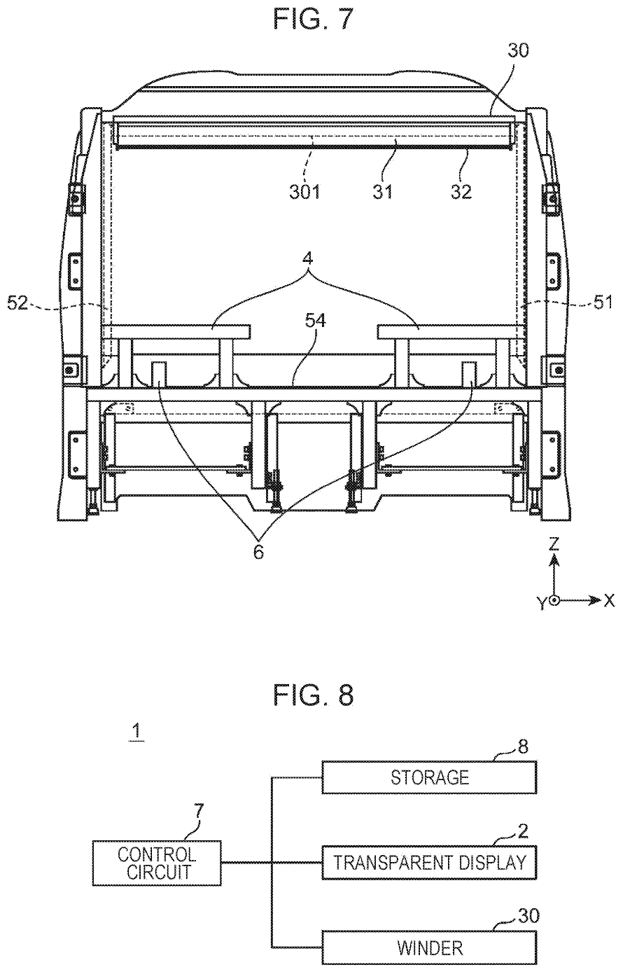

Next, the structure of the frame 5, which supports the transparent display 2, the light blocking screen 3, and the seat stopper 4, will be described. FIG. 5 illustrates an example of a side view of the display unit 1. FIG. 6 illustrates an example of a perspective view the display unit 1. FIG. 7 illustrates an example of a front view of the display unit 1.

The frame 5 includes a pair of support members 51 and 52 (FIGS. 5 to 7) extending in the up-down direction (the Z direction). The pair of support members 51 and 52 (FIGS. 5 to 7) support both ends of the transparent display 2 in the left-right direction (the X direction). Therefore, vibration of the transparent display 2 in the left-right direction during travelling of the vehicle 9 is reduced. Thus, it is possible to reduce the frequency at which an occupant in the rear seat 92, who is watching image contents displayed on the display surface 21, suffers from sickness such as carsickness.

One of the pair of support members 51 and 52 (FIGS. 5 to 7) may be omitted so that only one end of the transparent display 2 in the left-right direction (the X direction) is supported. The expression “only one end of the transparent display 2 in the left-right direction (the X direction) is supported” may be interpreted as “a first end is supported and a second end is not supported” or “a first end is not supported and a second end is supported”. The transparent display 2 may include the first end and the second end in the left-right direction (the X direction). The first end may face the second end.

The frame 5 further includes a support member 53 (FIGS. 5 and 6) extending in the left-right direction (the X direction). The support member 53 (FIGS. 5 and 6) is a member that supports the upper end of the transparent display 2 and the winder 30 of the light blocking screen 3. The support member 53 (FIGS. 5 and 6) is attached to the upper ends of the pair of support members 51 and 52.

Therefore, when the winder 30 pulls out one end of the light blocking member 31 (FIG. 3) to which the weight bar 32 is attached downward, it is possible to move the one end downward by using the weights of the light blocking member 31 (FIG. 3) and the weight bar 32. Thus, it is possible to reduce the rotational force of the winding shaft 301 that is necessary for the winder 30 to pull out the one end downward.

One end of the support member 53 (FIGS. 5 and 6) in the left-right direction may be attached to the upper end of one of the pair of support members 51 and 52 (FIGS. 5 to 7) so that the other end of the support member 53 (FIGS. 5 and 6) in the left-right direction is not supported.

The frame 5 further includes a support member 54 (FIGS. 5 to 7) extending in the left-right direction (the X direction). The support member 54 (FIGS. 5 to 7) is a member that supports the seat stopper 4 and the bracket 6.

Both rear (the −Y direction) ends of the support member 54 (FIGS. 5 to 7) in the left-right direction (the X direction) are attached to the pair of support members 51 and 52 (FIGS. 5 to 7). The support member 54 (FIGS. 5 to 7) supports the bracket 6 at a position that is below (in the −Z direction of) the lower end of the transparent display 2 and that is in front (the +Y direction) of the back surface 22. Therefore, it is possible to reduce the probability that the light blocking member 31 contacts the back surface 22 when the weight bar 32 is fixed to the bracket 6.

To the front (the +Y direction) surface of the support member 54 (FIGS. 5 to 7), the seat stopper 4 is attached so as to face the front seat 91. Therefore, it is possible to separate the seat stopper 4 from the pair of support members 51 and 52 (FIGS. 5 to 7) by the length of the support member 54 (FIGS. 5 to 7) in the front-back direction (the Y direction). Thus, it is possible to limit the movable range when the front seat 91 is moved toward the rear seat 92 for reclining or the like. As a result, it is possible to reduce the risk that the front seat 91 contacts the light blocking screen 3.

Next, the electrical configuration of the display unit 1 will be described. FIG. 8 is a block diagram illustrating an example of the electrical configuration of the display unit 1. The display unit 1 further includes a storage 8 and the control circuit 7.

The storage 8 is a nonvolatile rewritable storage device such as a hard disk drive or a solid-state drive. The storage 8 stores data of image contents to be displayed on the display surface 21. The image contents include phases. As the phases, for example, a relaxing phase, a sleeping phase following the relaxing phase, and an awakening phase following the sleeping phase can be used.

The relaxing phase is a phase for guiding an occupant in the rear seat 92 to a relaxed state. Image contents of the relaxing phase are, for example, image contents in which a forest landscape and/or a lush river are/is recorded. The sleeping phase is a phase for guiding an occupant in the rear seat 92 to a sleeping state. Image contents of the sleeping phase are, for example, abstract images such as signal waveforms. The awakening phase is a phase for guiding an occupant in the rear seat 92 to an awakened state. Image contents of the awakening phase are, for example, image contents in which a dawn scene and/or a daytime grassland scene are/is recorded.

However, phases included in image contents and the order of the phases are not limited to the above. The storage 8 may store the data of image contents without dividing the data for each phase, or may store the data by dividing the data for each phase.

The storage 8 further stores information representing the end timing of each phase (hereafter, referred to as “end timing information”) beforehand. The end timing of each phase is determined, for example, based on the elapsed time from the time when the image contents of the first phase are displayed on the display surface 21. However, the end timing of each phase is not limited to this, and may be determined based on the clock time.

The storage 8 may store information representing the start timing of each phase (hereafter, referred to as “start timing information”) beforehand, in the same way as the end timing information. The storage 8 may store the start timing information beforehand without storing the end timing information beforehand.

The control circuit 7 includes a central processing unit (CPU) (not shown) and a memory such as a ROM and a RAM (not shown). The control circuit 7 is communicably connected to the storage 8, the transparent display 2, and the winder 30. The control circuit 7 may be an ECU (Electronic Control Unit), which is standard equipment of the vehicle 9, or may be configured independently from the ECU.

The control circuit 7 reads image contents and timing information stored in the storage 8. The control circuit 7 controls the transparent display 2 to display image contents on the display surface 21. The control circuit 7 controls opening and closing of the light blocking screen 3 by controlling a motor (not shown) included in the winder 30 to rotate the winding shaft 301 around the X axis.

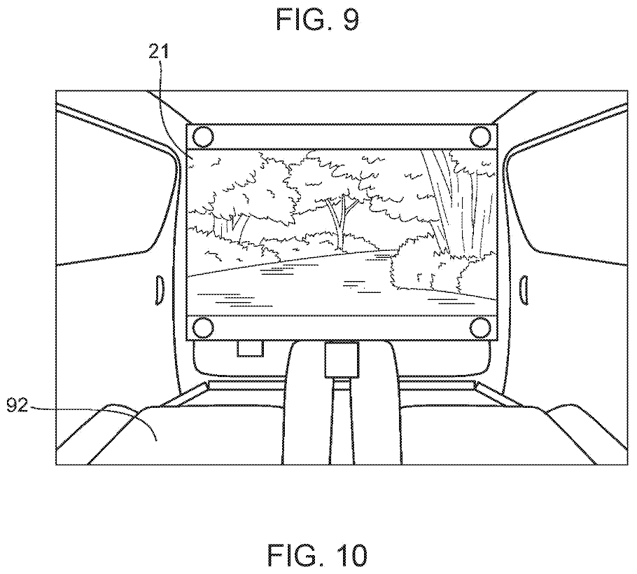

FIGS. 9 to 11 each illustrate an example of the visibility of the transparent display 2 in the rear seat 92. To be specific, when the control circuit 7 receives from the ECU a control signal representing a command for starting display of image contents, the control circuit 7 starts processing for displaying the image contents. The control signal representing the command for starting display is input to the ECU as an occupant manipulates a manipulator, such as a tablet terminal, mounted in the vehicle 9.

When the data of image contents is stored in the storage 8 without being divided for each phase, the control circuit 7 reads the data of image contents and the timing information from the storage 8. The control circuit 7 outputs to the transparent display 2 a control signal representing a command for displaying the image contents on the display surface 21, together with the data of the image contents. Thus, in accordance with the command represented by the control signal, the transparent display 2 displays on the display surface 21 the image contents represented by the data received together with the control signal.

Moreover, the control circuit 7 controls opening and closing of the light blocking screen 3 to guide an occupant in the rear seat 92 to a state corresponding to the phase displayed on the display surface 21 by controlling a motor (not shown) included in the winder 30.

For example, it is assumed that image contents include a relaxing phase, a sleeping phase following the relaxing phase, and an awakening phase following the sleeping phase, as described above. In this case, in order to guide an occupant in the rear seat 92 to a relaxed state corresponding to the relaxing phase, which is the first phase, the control circuit 7 causes the light blocking screen 3 to enter a closed state by controlling a motor (not shown) included in the winder 30.

Thus, light that travels from the back surface 22 (FIG. 3) toward the display surface 21 (FIG. 3) of the transparent display 2 is blocked. Therefore, for example, as illustrated in FIG. 9, the image contents of the relaxing phase are displayed on the display surface 21 without being transmitted. As a result, it is possible to guide an occupant in the rear seat 92 to the relaxed state by causing the occupant to watch the image contents of the relaxing phase.

The control circuit 7 refers to the timing information, and when the control circuit 7 determines that the end timing of the relaxing phase has arrived, in order to guide the occupant in the rear seat 92 to the sleeping state corresponding to the sleeping phase following the relaxing phase, the control circuit 7 continues to cause the light blocking screen 3 to be in the closed state.

Thus, from the time when the image contents of the relaxing phase are displayed, light that travels from the back surface 22 (FIG. 3) toward the display surface 21 (FIG. 3) of the transparent display 2 continues to be blocked. Therefore, in the same way as in FIG. 9, the image contents of the sleeping phase are displayed on the display surface 21 without being transmitted. As a result, it is possible to guide an occupant in the rear seat 92 to the sleeping state by causing the occupant to watch the image contents of the sleeping phase.

The control circuit 7 refers to the timing information, and when the control circuit 7 determines that the end timing of the sleeping phase has arrived, in order to guide the occupant in the rear seat 92 to the awakened state corresponding to the awakening phase following the sleeping phase, the control circuit 7 causes the light blocking screen 3 to be in the open state by controlling a motor (not shown) included in the winder 30.

Thus, light that travels from the back surface 22 (FIG. 2) toward the display surface 21 (FIG. 2) of the transparent display 2 is transmitted. Therefore, for example, as illustrated in FIG. 10, it is possible to allow an occupant in the rear seat 92 to simultaneously see the image contents of the awakening phase displayed on the display surface 21 and a view in the travelling direction of the vehicle 9 such as the front seat 91. As a result, it is possible to allow the occupant in the rear seat 92 to recognize that the vehicle 9 is moving and to guide the occupant to an awakened state.

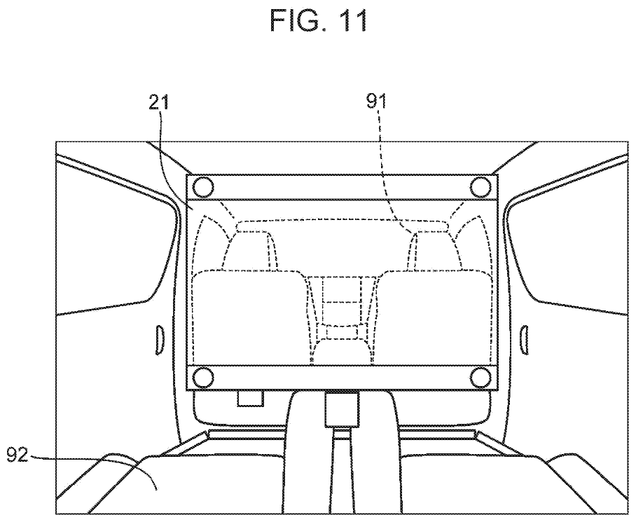

Then, the control circuit 7 refers to the timing information, and when the control circuit 7 determines that the end timing of the awakening phase has arrived, the control circuit 7 finishes controlling the transparent display 2 and the winder 30. Thus, the image contents are stopped being displayed on the display surface 21, and, because the light blocking screen 3 is in an open state, light that travels from the back surface 22 toward the display surface 21 (FIG. 2) of the transparent display 2 is transmitted. Therefore, as illustrated in FIG. 11, an occupant in the rear seat 92 can see the view in the travelling direction of the vehicle 9, including the front seat 91 and the like that is in front (the +Y direction) of the transparent display 2.

It is assumed that the data of image contents are divided for each phase and stored in the storage 8. In this case, the control circuit 7 reads the data of image contents of the first phase from the storage 8, and displays the image contents on the display surface 21. Subsequently, the control circuit 7 may read the data of image contents of the next phase from the storage 8 at a timing when the control circuit 7 determines that the end timing of each phase has arrived and display the image contents of the next phase on the display surface 21.

When the start timing information is stored in the storage 8, the control circuit 7 may refer to the start timing information and control the transparent display 2 and the winder 30 in the same way as described above at the timing when the control circuit 7 determines that the start timing of each phase has arrived.

The present disclosure includes the following modifications.
(1) In the embodiment described above, an example in which the light blocking screen 3 (FIGS. 2 and 3) is a roll screen that winds up the sheet-like light blocking member 31 has been described. However, the light blocking screen 3 may be a curtain screen that opens and closes a curtain-like light blocking member, which has a light blocking ratio equivalent to that of the light blocking member 31, in the left-right direction (the X direction) under the control of the control circuit 7.
(2) In the embodiment described above, an example in which the winder 30 of the light blocking screen 3 (FIGS. 2 and 3) opens and closes the light blocking screen 3 in the up-down direction by pulling out the light blocking member 31 from above to below and by winding up the light blocking member 31 from below to above has been described. However, in contrast to the embodiment described above, the winder 30 may be disposed below the lower end of the transparent display 2. Thus, the winder 30 may open and close the light blocking screen 3 in the up-down direction by pulling out the light blocking member 31 from below to above and by winding up the light blocking member 31 from above to below.

Likewise, the winder 30 may be disposed to the left of the left end of the transparent display 2 so that the winder 30 opens and closes the light blocking screen 3 in the left-right direction by pulling out the light blocking member 31 from left to right and by winding up the light blocking member 31 from right to left. In contrast to this, the winder 30 may be disposed to the right of the right end of the transparent display 2 so that the winder 30 opens and closes the light blocking screen 3 in the left-right direction by pulling out the light blocking member 31 from right to left and by winding up the light blocking member 31 from left to right.
(3) The control circuit 7 may control opening and closing of the light blocking screen 3 in accordance with a command input by an occupant of the vehicle 9. In this case, it is possible to open and close the light blocking screen 3 at any appropriate timing in consideration of the physical condition and/or mood of the occupant of the vehicle 9. This configuration can be realized, for example, as follows.

To be specific, when the control circuit 7 receives a control signal representing a command for opening or closing the light blocking screen 3, the control circuit 7 opens or closes the light blocking screen 3 by controlling a motor (not shown) included in the winder 30 in accordance with the control signal.

The control signal representing the command for opening or closing the light blocking screen 3 is, for example, input by an occupant in the rear seat 92 via a user interface presented by a computer of a tablet terminal or the like mounted in the vehicle 9, and then the control signal is input to the control circuit 7 via the ECU or is input to the control circuit 7 via wired communication or wireless communication.

The control signal may be input by an occupant in the rear seat 92 via a user interface presented by, instead of a computer of a tablet terminal or the like mounted in the vehicle 9, for example, a computer of a mobile terminal such as a smart phone or a smart watch owned by the occupant in the rear seat 92. The control signal may be input by an occupant in the front seat 91 via a user interface presented by a car navigation system or the like that can be manipulated in the front seat 91.

The technique of the present disclosure is applicable to the technical field of in-vehicle devices.

What is claimed is:

1. A display unit to be disposed in a mobile body, comprising:
a transparent image projection member that has a display surface and a back surface; and
a light blocking screen that opens and closes so as to face the back surface,
wherein the image projection member is positioned between a rear seat of the mobile body and the light blocking screen, and is disposed so that the display surface and a view in a travelling direction of the mobile body overlap as seen from the rear seat.

2. The display unit according to claim 1,
wherein the light blocking screen is a roll screen that winds up a sheet-like light blocking member, and
wherein a winding slot for the light blocking member is provided at a position that is closer than a winding shaft for the light blocking member to the back surface.

3. The display unit according to claim 1, further comprising:
a stopper member that stands between a front seat of the mobile body and the light blocking screen so as to face the front seat.

4. The display unit according to claim 1,
wherein the light blocking screen is a roll screen that winds up a sheet-like light blocking member,
wherein the light blocking member includes one end at which a weight bar is provided and the other end at which a winding shaft is provided,
wherein the one end faces the other end, and
wherein the display unit further includes, in a direction from the winding shaft along the back surface, a bracket that removably holds the weight bar with a magnetic force.

5. The display unit according to claim 1, further comprising:
a control circuit,
wherein the control circuit displays image contents on the display surface,
wherein the image contents include phases, and
wherein the control circuit controls opening and closing of the light blocking screen in accordance with a phase displayed on the display surface.

6. The display unit according to claim 5,
wherein the phases include a relaxing phase for guiding an occupant in the rear seat to a relaxed state, a sleeping phase for guiding the occupant to a sleeping state, and an awakening phase for guiding the occupant to an awakened state.

7. The display unit according to claim 3,
wherein the stopper member is disposed so as to satisfy
(b/a)<(A/B),
where a is a distance from a bottom surface of the front seat to an upper end of the stopper member in an up-down direction of the mobile body,
b is a distance from a rear end of the bottom surface of the front seat to the stopper member in the travelling direction of the mobile body,
A is a distance in the up-down direction from the bottom surface of the front seat to a point of contact between the front seat and the light blocking screen when the front seat is in contact with the light blocking screen, and
B is a distance from the light blocking screen to the rear end of the bottom surface of the front seat in the travelling direction.

8. The display unit according to claim 1, further comprising:
a control circuit,
wherein the control circuit controls opening and closing of the light blocking screen in accordance with a command that is input by an occupant of the mobile body.

9. A mobile body including a display unit,
wherein the display unit includes
a transparent image projection member that has a display surface and a back surface, and
a light blocking screen that opens and closes so as to face the back surface, and
wherein the image projection member is positioned between a rear seat of the mobile body and the light blocking screen, and is disposed so that the display surface and a view in a travelling direction of the mobile body overlap as seen from the rear seat.
